(19) United States
(12) Patent Application Publication
(10) Pub. No.: US 2005/0090602 A1
(43) Pub. Date: Apr. 28, 2005

(54) Low-contaminating adhesive composition

(75) Inventor: Hidenori Koshikawa, Gurma-ken (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 10/972,321

(22) Filed: Oct. 26, 2004

(30) Foreign Application Priority Data
Oct. 27, 2003 (JP) 2003-365397

(51) Int. Cl. C11D 1/00

(52) U.S. Cl. 524/544

(57) ABSTRACT

In an adhesive composition comprising (A) a linear perfluoropolyether compound containing at least two alkenyl groups, (B) a fluorinated organohydrogensiloxane containing at least two silicon-bonded hydrogen atoms, (C) a platinum catalyst, and (D) an organosiloxane containing at least one silicon-bonded hydrogen atom and at least one epoxy and/or trialkoxysilyl group, the weight loss of components (A), (B) and (D) are controlled. The composition yields minimized outgassing during heat curing, adheres firmly to various types of substrates including metals and plastics, and cure into products having many advantages.

### CROSS-REFERENCE TO RELATED APPLICATION

This non-provisional application claims priority under 35 U.S.C. §119(a) on Patent Application No. 2003-365397 filed in Japan on Oct. 27, 2003, the entire contents of which are hereby incorporated by reference.

### TECHNICAL FIELD

This invention relates to adhesive compositions which yield minimized outgassing during heat curing, adhere firmly to various types of substrates including metals and plastics, and cure into products having many advantages including solvent resistance, chemical resistance, heat resistance, low-temperature properties, low moisture permeation and electrical properties.

### BACKGROUND ART

Fluoroelastomer compositions which can be cured by an addition reaction between alkenyl groups and hydrosilyl groups have been known for some time. JP-A 9-95615 proposes a similar composition further comprising an organopolysiloxane bearing hydrosilyl groups and epoxy and/or trialkoxysilyl groups as a third component. The latter composition can be cured by a short period of heating to give a cured product having many advantages including solvent resistance, chemical resistance, heat resistance, low-temperature properties, low moisture permeation and electrical properties. Such compositions are used in adhesive applications within a variety of fields where these properties are required.

It is pointed out that upon heat curing, these compositions give off gaseous impurities, known as an “outgassing” phenomenon, thus contaminating the surrounding parts which run into trouble. For instance, when the composition is used as a sealant in the head section of an ink jet printer, the ink channel is contaminated with outgases released from the composition upon heat curing, whereby the ink output through the channel is altered.

It is believed that the outgassing occurs because low-molecular weight components such as perfluoropolyether compounds having a low degree of polymerization and fluorinated organohydrogensiloxane volatilize off the composition when heated.

### SUMMARY OF THE INVENTION

An object of the present invention is to provide adhesive compositions which yield minimized outgassing during heat curing, adhere firmly to various types of substrates including metals and plastics, and cure into products having many advantages including solvent resistance, chemical resistance, heat resistance, low-temperature properties, low moisture permeation and electrical properties.

The inventors have discovered that using a base polymer and a crosslinker in which the content of low-molecular weight components that cause outgassing is minimized, an adhesive composition is obtained which yields no or little outgassing upon heat curing.

The present invention provides an adhesive composition comprising
(A) 100 parts by weight of a linear perfluoropolyether compound containing at least two alkenyl groups per molecule and having a weight loss of up to 0.3%,
(B) a fluorinated organohydrogensiloxane containing at least two silicon atom-bonded hydrogen atoms per molecule and having a weight loss of up to 2.0%, in an amount to provide 0.5 to 3.0 moles of Si—H groups per mole of alkenyl groups in component (A),
(C) 0.1 to 500 ppm of a platinum group compound, calculated as platinum group metal atoms on the basis of the total weight of the composition, and
(D) 1 to 50 parts by weight of an organosiloxane containing per molecule at least one hydrogen atom directly bonded to a silicon atom and at least one group selected from among epoxy and trialkoxysilyl groups which is bonded to a silicon atom through a carbon atom or carbon and oxygen atoms and having a weight loss of up to 2.0%.

When heat cured, the adhesive composition of the present invention produces minimized outgassing and adheres firmly to various types of substrates including metals and plastics. The cured product has many advantages including solvent resistance, chemical resistance, heat resistance, low-temperature properties, low moisture permeation and electrical properties.

### DESCRIPTION OF THE PREFERRED EMBODIMENTS

It is noted that throughout the specification, Me stands for methyl and Ph stands for phenyl.

Component A

Component (A) which is used in the adhesive composition of the invention is a linear fluoropolyether compound containing at least two alkenyl groups per molecule and a divalent perfluoroalkyl ether structure in its backbone. The perfluoropolyether compound should have a weight loss or heat loss of up to 0.3%, and preferably up to 0.1%. If the perfluoropolyether compound has a weight loss of more than 0.3%, an adhesive composition containing the same gives off gases upon heat curing, causing unwanted contamination.

The “weight loss” is determined as follows. First, the tare weight (W₁) of a clean aluminum dish is measured using a precision balance (reading limit 0.1 mg). A sample of test material is then placed on the dish, and the weight (W₂) of the sample-containing aluminum dish is measured using the precision balance. The sample-containing aluminum dish is held in a thermostat oven at 105° C. for 3 hours. After heating, the aluminum dish is taken out of the oven and allowed to cool down in a desiccator. After cooling, the weight (W₃) of the sample-containing aluminum dish is measured again using the precision balance. Then the percent weight loss of this sample is computed according to the formula:
[(W₃−W₁)/(W₂−W₁)]×100%.
W₁: weight (g) of aluminum dish
W₂: weight (g) of aluminum dish+sample prior to heating
W₃: weight (g) of aluminum dish+heated sample

The linear fluoropolyether compound (A) should preferably have a molecular weight of at least 2,000, more preferably at least 4,000. Linear fluoropolyether compounds having a molecular weight of less than 2,000 are undesirable because they will volatilize upon heat curing, incurring outgassing and hence, contamination.

In the linear fluoropolyether compound (A), alkenyl groups are preferably those of 2 to 8 carbon atoms, especially 2 to 6 carbon atoms, terminated with a CH₂═CH— structure. Examples include vinyl, allyl, propenyl, isopropenyl, butenyl and hexenyl, with the vinyl and allyl being especially preferred.

With respect to its structure, the linear fluoropolyether compound (A) is preferably of the general formula (2).
CH₂═CH—(X)ₚ—(CF(CF₃)—CF₂—O)_{q}—(X′)ₚ—CH═CH₂ (2)
Herein, X is —CH₂—, —CH₂O—, —CH₂OCH₂— or —Y—NR—CO—, wherein Y is —CH₂— or an o-, m- or p-dimethylsilylphenylene group of structural formula (3): 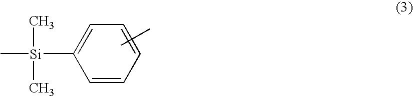
and R is hydrogen or a substituted or unsubstituted monovalent hydrocarbon group. X′ is —CH₂—, —OCH₂—, —CH₂OCH₂— or —CO—NR—Y′—, wherein Y′ is —CH₂— or an o-, m- or p-dimethylsilylphenylene group of structural formula (4): 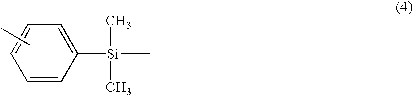
and R is as defined above. The subscript p is independently 0 or 1, and q is an integer of 0 to 400.

R is a hydrogen atom or a monovalent hydrocarbon group, preferably having 1 to 12 carbons, and more preferably 1 to 10 carbons. Examples of suitable hydrocarbon groups include alkyl groups such as methyl, ethyl, propyl, butyl, hexyl, cyclohexyl and octyl; aryl groups such as phenyl and tolyl; aralkyl groups such as benzyl and phenylethyl; and substituted monovalent hydrocarbon groups in which some or all of the hydrogen atoms are substituted with halogen atoms such as fluorine. Inter alia, hydrogen, methyl, phenyl and aryl are preferred.

The alkenyl groups in the linear fluoropolyether compound (A) are those of 2 to 8 carbon atoms, especially 2 to 6 carbon atoms, having a CH₂═CH— structure at an end. Examples include vinyl, allyl, propenyl, isopropenyl, butenyl and hexenyl, with the vinyl and allyl being especially preferred.

Typical of the linear fluoropolyether compound (A) are linear perfluoropolyether compounds of the general formula (1): 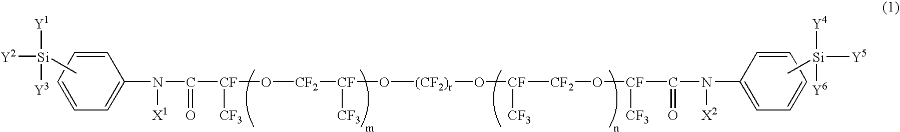
wherein X¹ and X² each are hydrogen, methyl, phenyl or aryl, at least two of Y¹, Y², Y³, Y⁴, Y⁵ and Y⁶ are alkenyl groups, the remaining Y's are substituted or unsubstituted monovalent hydrocarbon groups, r is an integer of 2 to 6, m and n each are an integer of 0 to 200, and the sum of m and n is 0 to 400, the compounds experiencing a weight loss of up to 0.3% when heated at 105° C. for 3 hours. The linear perfluoropolyether compound of formula (1) with a weight loss of up to 0.3% is designated Polymer P, hereinafter.

The linear fluoropolyether compounds of formula (1) should desirably have a number average molecular weight of 4,000 to 100,000, more desirably 5,000 to 25,000, as measured by the method described in JP-A 9-95615.

In the linear fluoropolyether compounds of formula (1), the content of alkenyl groups is preferably 0.002 to 0.3 mol/100 g, more preferably 0.008 to 0.12 mol/100 g. An alkenyl content of less than 0.002 mol/100 g is undesirable because such a linear fluoropolyether compound may crosslink to an insufficient extent and become under-cured. An alkenyl content of more than 0.3 mol/100 g is undesirable because such a linear fluoropolyether compound may cure into a rubber elastomer having degraded mechanical properties.

Specific examples of the linear fluoropolyether compound having formula (1) are given below. 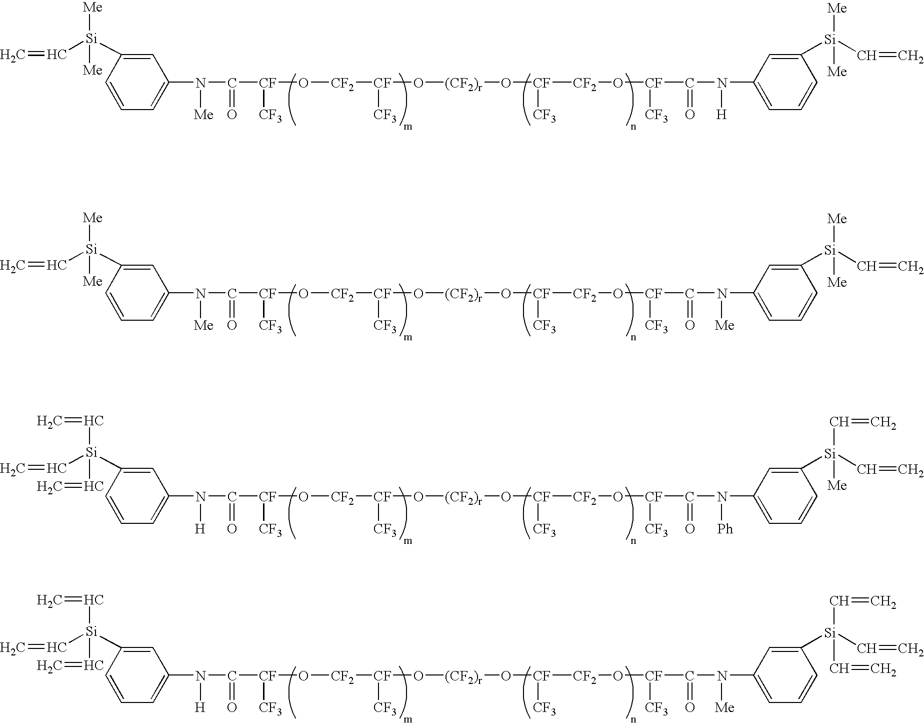
It is noted that m+n is an integer of 0 to 400, and r is an integer of 2 to 6.

The linear perfluoropolyether compounds of formula (1) include perfluoropolyether compounds having a relatively low degree of polymerization, of which those having a molecular weight of less than 2,000 become the cause of outgassing.

These linear fluoropolyether compounds may be used alone or in combination of two or more as component (A).

Then the linear perfluoropolyether compounds of formula (1) are subjected to the following Treatment 1 for removing low-molecular-weight fractions whereupon Polymer P suited as component (A) in the inventive composition is obtained.

Treatment 1: The linear perfluoropolyether compound of formula (1) is subjected to vacuum treatment at a temperature of 100 to 300° C., preferably 150 to 250° C. and a pressure of up to 1330 Pa, preferably up to 665 Pa, for a period of at least 1 hour, preferably at least 5 hours.

The linear perfluoropolyether compound (A) should preferably have a viscosity at 23° C. of 2,000 to 100,000 mPa·s, more preferably 3,000 to 50,000 mPa·s, and most preferably 3,500 to 20,000 mPa·s. This viscosity range ensures that when the composition is used for sealing, potting, coating and impregnating purposes, the composition maintains appropriate physical properties even in the cured state. For a particular application, an optimum viscosity may be selected within the above viscosity range.

Component B

Component (B) functions as a crosslinker and chain extender for component (A). It is a fluorinated organohydrogensiloxane containing at least two hydrogen atoms each directly bonded to a silicon atom per molecule and having a weight loss of up to 2.0%.

For good compatibility with component (A), dispersibility, and uniformity after curing, it is preferable for the fluorinated organohydrogensiloxane (B) to contain per molecule at least one fluorine-containing group selected from among monovalent perfluoroalkyl, monovalent perfluorooxyalkyl, divalent perfluoroalkylene and divalent perfluorooxyalkylene groups.

The fluorinated organohydrogensiloxane (B) should have a weight loss of up to 2.0%, and preferably up to 0.5%. If the fluorinated organohydrogensiloxane (B) has a weight loss of more than 2.0%, an adhesive composition containing the same gives off gases upon heat curing, causing unwanted contamination.

The fluorinated organohydrogensiloxane (B) should preferably have a molecular weight of 2,000 to 20,000, more preferably 4,000 to 10,000. Fluorinated organohydrogensiloxanes having a molecular weight of less than 2,000 are undesirable because they will volatilize upon heat curing, incurring outgassing and hence, contamination. Fluorinated organohydrogensiloxanes having a molecular weight of more than 20,000 are undesirable because they cause a substantial viscosity buildup which interferes with compounding operation.

In component (B), the fluorine-containing groups include those of the following formulas:
CₖF₂ₖ₊₁—
wherein k is an integer from 1 to 20, and preferably from 2 to 10,
—C_{g}F_{2g}—
wherein g is an integer from 1 to 20, and preferably from 2 to 10, 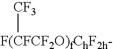
wherein f is an integer from 2 to 200, and preferably from 2 to 100, and h is an integer from 1 to 3, 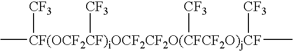
wherein i and j are each an integer of at least 1, and the average of the sum i+j is from 2 to 200, and preferably from 2 to 100, and
—(CF₂O)ₗ—(CF₂CF₂O)ₛ—CF₂—
wherein l and s are each an integer from 1 to 50.

Divalent linkages for connecting the perfluoroalkyl, perfluorooxyalkyl, perfluoroalkylene or perfluorooxyalkylene groups with silicon atoms include alkylene groups, arylene groups and combinations thereof, as well as any of these together with an intervening ether-bonding oxygen atom, amide linkage or carbonyl linkage. Preferred divalent linkages are of the general formula (5):
—(CH₂)ₜ—X″— (5)
wherein X″ is —OCH₂— or —Y″—NR′—CO— wherein Y″ is —CH₂— or a o, m or p-dimethylsilylphenylene group of structural formula (6): 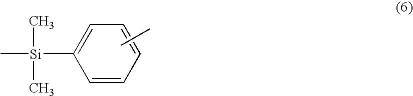
and R′ is hydrogen or a substituted or unsubstituted monovalent hydrocarbon group; and t is an integer of 1 to 10, preferably 1 to 5.

Of the organohydrogensiloxanes having such fluorine-containing groups (B), typical compounds are given below. These compounds may be used alone or in admixture of two or more.

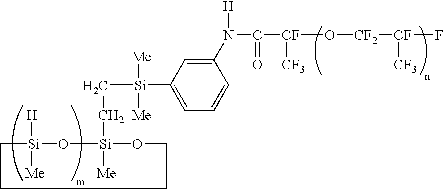

Herein, m=3 or 4, and n=20 to 40.

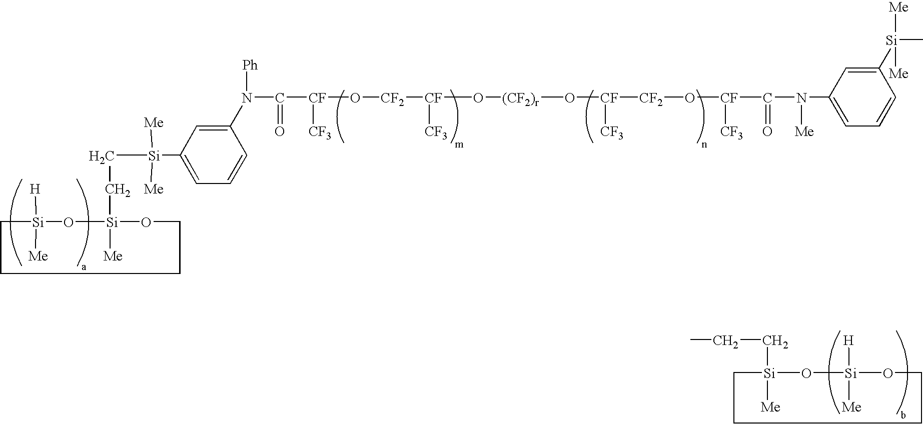

Herein, a=3 or 4, b=3 or 4, m=10 to 20, n=10 to 20, and r=2 to 6.

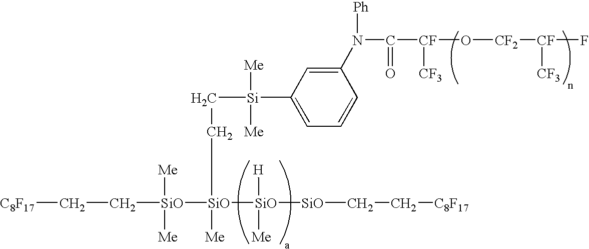

Herein, a=10 to 20, and n=20 to 40.

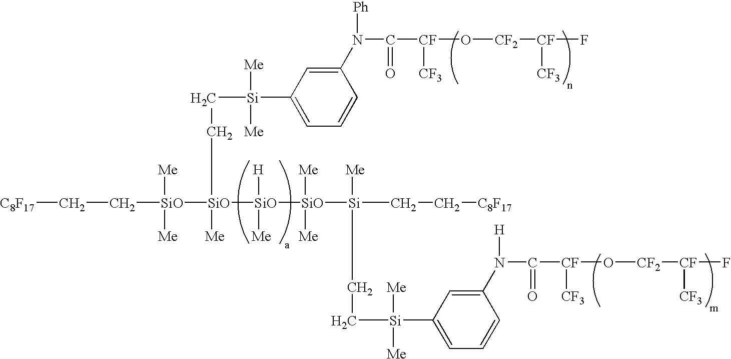

Herein, a=10 to 20, m=10 to 20, and n=10 to 20. It is understood that all subscripts like “a” and “n” are integers in the indicated range.

Component (B) is compounded in an amount effective for curing component (A), specifically in an amount to provide 0.5 to 3.0 moles, preferably 0.8 to 2.0 moles, of hydrosilyl groups (i.e., Si—H groups) per mole of alkenyl groups (e.g., vinyl, allyl, cycloalkenyl) in component (A). If there are too few hydrosilyl (≡Si—H) groups, a sufficient degree of crosslinking will not be reached, failing to provide a properly cured product. On the other hand, too many hydrosilyl groups will result in foaming during the curing process.

Component C

Component (C) is a platinum group compound serving as a catalyst for hydrosilylation reaction. The hydrosilylation catalyst promotes addition reactions between alkenyl groups in component (A) and hydrosilyl groups in component (B). Such catalysts are generally noble metal compounds which are expensive. Of these, platinum or platinum compound catalysts are often used because they are more readily available.

Exemplary platinum compounds include chloroplatinic acid, complexes of chloroplatinic acid with olefins such as ethylene or with alcohols or vinyl siloxane, and metallic platinum on supports such as silica, alumina and carbon. Known platinum group metal catalysts other than platinum compounds include rhodium, ruthenium, iridium and palladium compounds, specific examples of which are RhCl(PPh₃)₃, RhCl(CO)(PPh₃)₂, Ru₃(CO)₁₂, IrCl(CO)(PPh₃)₂ and Pd(PPh₃)₄.

If these catalysts are solid catalysts, they may be used in a solid state. However, to obtain a more uniform cured product, it is preferable to dissolve chloroplatinic acid or a complex thereof in a suitable solvent, and intimately mix the resulting solution with the linear polyfluoro compound (A).

Component (C) is used in a catalytic amount, specifically in an amount of 0.1 to 500 ppm, calculated as platinum group metal atoms on the basis of the weight of component (A).

Component D

Component (D) is an organosiloxane which is included to confer the inventive composition with sufficient self-adhesiveness. The organosiloxane bears on each molecule at least one hydrogen atom directly bonded to a silicon atom and at least one group selected from among epoxy groups and trialkoxysilyl groups which is bonded to a silicon atom through an intervening carbon atom or through intervening carbon and oxygen atoms. The organosiloxane should have a weight loss of up to 2.0%.

Preferred organosiloxanes are those which have also at least one monovalent perfluoroalkyl or monovalent perfluorooxyalkyl group bonded to a silicon atom through an intervening carbon atom or through intervening carbon and oxygen atoms.

The organosiloxane (D) should have a weight loss of up to 2.0%, and preferably up to 0.5%. If the organosiloxane has a weight loss of more than 2.0%, an adhesive composition containing the same gives off gases upon heat curing, causing unwanted contamination.

The organosiloxane (D) should preferably have a molecular weight of 2,000 to 20,000, more preferably 4,000 to 10,000. The presence of organosiloxanes having a molecular weight of less than 2,000 in the adhesive composition is undesirable because they will volatilize upon heat curing, incurring outgassing and hence, contamination. Organosiloxanes having a molecular weight of more than 20,000 are undesirable because they cause a substantial viscosity buildup which interferes with compounding operation.

The organosiloxane has a siloxane backbone which may be cyclic, linear or branched, or a combination of any of these. Organosiloxanes that can be used herein include those having the following average compositional formulas.

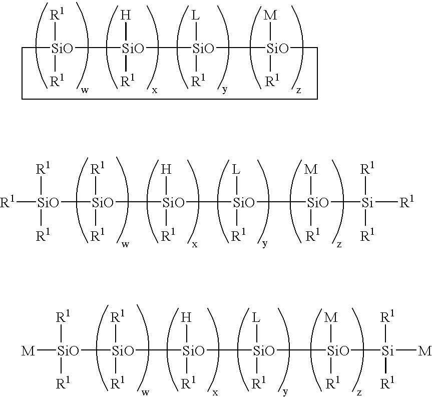

In these formulas, R¹ is a halogen-substituted or unsubstituted monovalent hydrocarbon group, L and M are as described below, the subscript w is an integer from 0 to 50, preferably from 0 to 20, x is an integer from 1 to 50, preferably from 1 to 20, y is an integer from 1 to 50, preferably from 1 to 20, and z is an integer from 0 to 50, preferably from 0 to 20. The sum of w+x+y+z is such an integer that the organosiloxane may have a molecular weight of 2,000 to 20,000.

R¹ is a halogen-substituted and unsubstituted monovalent hydrocarbon group, preferably of 1 to 10 carbons, and more preferably 1 to 8 carbons. Specific examples include alkyl groups such as methyl, ethyl, propyl, butyl, hexyl, cyclohexyl and octyl; aryl groups such as phenyl and tolyl; aralkyl groups such as benzyl and phenylethyl; and substituted forms of the foregoing monovalent hydrocarbon groups in which some or all of the hydrogen atoms are substituted with fluorine or other halogen atoms. Of these, methyl is especially preferred.

L represents an epoxy group and/or trialkoxysilyl group which is bonded to a silicon atom through an intervening carbon atom or through intervening carbon and oxygen atoms. Specific examples are given below.

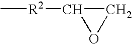

Herein, R² is a divalent hydrocarbon group with 1 to 10 carbons, and preferably 1 to 5 carbons, which may be separated by an oxygen atom, such as an alkylene or cycloalkylene group.
—R³—Si(OR⁴)₃

Herein, R³ is a divalent hydrocarbon group with 1 to 10 carbons, and preferably 1 to 4 carbons, such as an alkylene group, and R⁴ is a monovalent hydrocarbon group with 1 to 8 carbons, and preferably 1 to 4 carbons, such as an alkyl group.

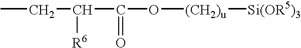

Herein, R⁵ is a monovalent hydrocarbon group with 1 to 8 carbons, and preferably 1 to 4 carbons, such as an alkyl group, R⁶ is hydrogen or methyl, and u is an integer from 2 to 10.

M preferably represents a structure of the general formula (7).
-Z-Rf (7)
Herein Z is —(CH₂)_{g}—, —(CH₂)ᵢ—OCH₂—, or —Y″′—NR″—CO—, wherein Y″′ is —CH₂— or an o-, m- or p-dimethylsilylphenylene group of structural formula (8): 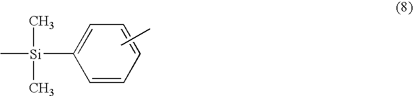
and R″ is hydrogen or a substituted or unsubstituted monovalent hydrocarbon group, g and j each are an integer of 1 to 10, and preferably 1 to 5. Rf is a monovalent perfluoroalkyl or perfluorooxyalkyl group. Examples of the monovalent perfluoroalkyl or perfluorooxyalkyl group include those of the following general formulas:
CₖF₂ₖ₊₁—
wherein k is an integer of 1 to 20, and preferably 2 to 10, and 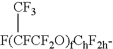
wherein f is an integer of 2 to 200, and preferably 2 to 100, and h is an integer of 1 to 3.

These organosiloxanes can be prepared through a partial addition reaction of a compound bearing an aliphatic unsaturated group (e.g., vinyl or allyl) and an epoxy group and/or trialkoxysilyl group and optionally, a compound bearing an aliphatic unsaturated group and a perfluoroalkyl or perfluorooxyalkyl group to an organohydrogenpolysiloxane bearing at least three silicon-bonded hydrogen atoms (Si—H groups) per molecule by a conventional method. The number of aliphatic unsaturated groups must be smaller than the number of Si—H groups.

In preparing the organosiloxane, the target substance may be isolated following reaction completion. Instead, the reaction mixture from which only unreacted feedstock and the addition reaction catalyst have been removed is also ready for use as the organosiloxane (D).

Specific examples of organosiloxanes which may be used as component (D) include those having the following structural formulas. These compounds may be used singly or as combinations of two or more thereof.

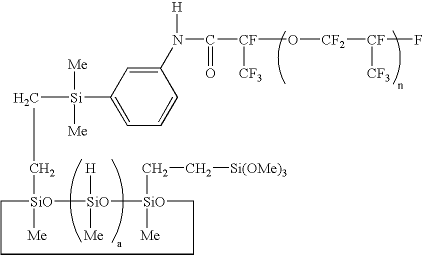

Herein, a=2 or 3, and n=20 to 40.

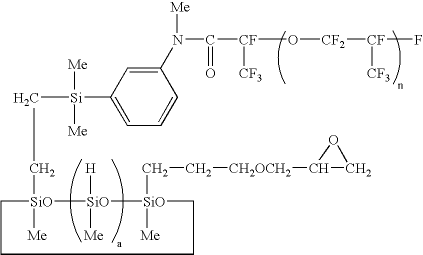

Herein, a=2 or 3, and n=20 to 40.

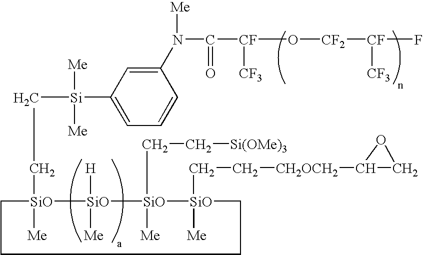

Herein, a=1 or 2, and n=20 to 40.

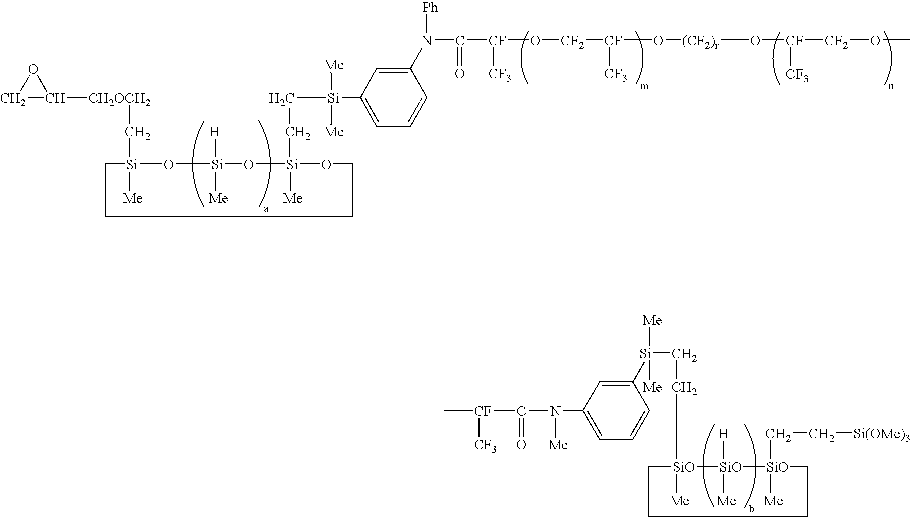

Herein, a=2 or 3, b=2 or 3, m=10 to 20, n=10 to 20, and r is 2 to 6. It is understood that all subscripts like “a” and “In” are integers in the indicated range.

Component (D) is included in an amount of 1 to 50 parts by weight, and preferably 10 to 40 parts by weight, per 100 parts by weight of component (A). Less than 1 part by weight of component (D) fails to achieve sufficient adhesion. On the other hand, at more than 50 parts by weight, the composition has a poor flow and less than desirable curability, and the resulting cured product has a diminished physical strength.

Other Components

In addition to above components (A) to (D), optional ingredients may also be included in the inventive composition to increase its utility. Suitable additives include plasticizers, viscosity modifiers, flexibilizers, hydrosilylation catalyst regulators, inorganic fillers, adhesion promoters, tackifiers other than component (D) and silane coupling agents. These additives may be included in any respective amounts that allow the objects of the invention to be attained and that do not compromise the properties of the composition or the cured product obtained therefrom.

For the plasticizers, viscosity modifiers and flexibilizers, polyfluoromonoalkenyl compounds of general formula (9) below and/or linear polyfluoro compounds of general formulas (10) and (11) below may be used.
Rf′-(X′)ₚCH═CH₂ (9)

In formula (9), X′ is as defined above, p is 0 or 1, and Rf′ has the following general formula: 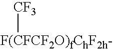
wherein f is an integer of 2 to 200, and preferably 2 to 100, h is an integer of 1 to 3, and the sum of f and h is smaller than the sum of m, n and r in formula (1) representing the linear perfluoropolyether compound.
Y—O—(CF₂CF₂CF₂O)_{c}—Y (10)

In formula (10), Y is a group of the formula C_{k′}F_{2k′+1}—, k′ being an integer of 1 to 3, and c is an integer which is from 1 to 200, but smaller than the sum of m, n and r in formula (1) representing the linear perfluoropolyether compound.
Y—O—(CF₂O)_{d}(CF₂CF₂O)ₑ—Y (11)

In formula (11), Y is as defined above, d and e are each integers of 1 to 200, and the sum of d and e is smaller than the sum of m, n and r in formula (1) representing the linear perfluoropolyether compound.

Specific examples of polyfluoromonoalkenyl compounds of above general formula (9) include the following, wherein m satisfies the above-indicated condition.

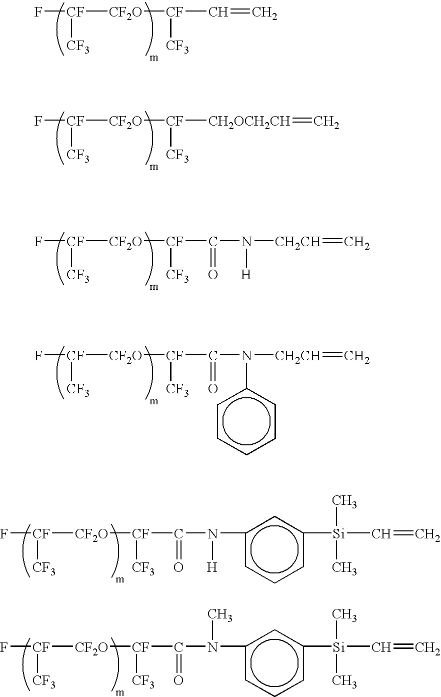

Specific examples of linear polyfluoro compounds of above general formulas (10) and (11) include the following.
CF₃O—(CF₂CF₂CF₂O)ₙ—CF₂CF₃
CF₃—[(OCF₂CF₂)ₙ(OCF₂)ₘ]—O—CF₃
In these formulas, m, n and the sum m+n satisfy the above-indicated conditions.

Polyfluoro compounds of formulas (9) to (11) may be included in the inventive composition in an amount of 1 to 300 parts by weight, and preferably 50 to 250 parts by weight, per 100 parts by weight of the linear perfluoropolyether compound (A). As with the linear perfluoropolyether compound (A), these polyfluoro compounds of formulas (9) to (11) desirably have a viscosity at 23° C. within the range of 2,000 to 100,000 mPa·s.

Examples of suitable hydrosilylation catalyst regulators include acetylenic alcohols such as 1-ethynyl-1-hydroxycyclohexane, 3-methyl-1-butyn-3-ol, 3,5-dimethyl-1-hexyn-3-ol, 3-methyl-1-penten-3-ol and phenylbutynol; the reaction products of chlorosilanes having monovalent fluorine-bearing substituents with acetylenic alcohols; 3-methyl-3-penten-1-yne, 3,5-dimethyl-3-hexen-1-yne and triallyl isocyanurate; polyvinylsiloxane, and organophosphorus compounds. The addition of these compounds helps to achieve a suitable curing reactivity and shelf stability.

Examples of inorganic fillers include reinforcing or semi-reinforcing fillers such as quartz powder, fused silica powder, diatomaceous earth and calcium carbonate; inorganic pigments such as titanium oxide, iron oxide, carbon black and cobalt aluminate; heat stabilizers such as titanium oxide, iron oxide, carbon black, cerium oxide, cerium hydroxide, zinc carbonate, magnesium carbonate and manganese carbonate; substances that confer thermal conductivity, such as alumina, boron nitride, silicon carbide and metal powders; and substances that confer electrical conductivity, such as carbon black, silver powder and conductive zinc oxide.

Adhesion promoters such as carboxylic anhydrides and titanic acid esters, tackifiers other than component (D) and/or silane coupling agents may also be added to the inventive composition.

Adhesive Composition

The adhesive composition of the invention can be prepared by uniformly mixing above components (A) to (D) and other optional ingredients using a suitable mixing apparatus, such as a planetary mixer, Ross mixer or Hobart mixer, and using also, if necessary, an apparatus for intimately working the mixture, such as a kneader or a three-roll mill.

No particular limitation is imposed on the method for preparing the curable compositions of the invention. For example, preparation may involve blending all of the components together. Alternatively, the components may be prepared as two separate compositions, which are then mixed at the time of use.

Depending on the functional groups on the linear perfluoropolyether compound (A) and the type of catalyst (C), the resulting adhesive composition will cure at room temperature. However, heating is desirable to promote curing. In particular, to achieve good adhesion to various types of substrates, the composition is preferably cured by heating at a temperature of at least 60° C., and preferably 100 to 200° C., for a period of from several minutes to several hours.

Depending on the particular application and purpose of use, the adhesive composition of the invention may be used in solution form. Specifically, prior to use, the composition is dissolved in a suitable fluorochemical solvent, such as 1,3-bis(trifluoromethyl)benzene, Fluorinate (available from 3M Corporation), perfluorobutyl methyl ether or perfluorobutyl ethyl ether to the desired concentration. The use of a solvent is especially preferred in thin-film coating applications.

The adhesive compositions of the invention are useful as adhesives for various types of electrical and electronic components. For example, the adhesive compositions are highly suitable as adhesives for ink jet printers, adhesives and sealants for printer heads, coatings for rolls and belts in laser printers and copiers, and adhesive sealants and coatings for various types of circuit boards.

### EXAMPLE

Examples of the invention and comparative examples are given below by way of illustration and not by way of limitation. All parts are by weight. Properties such as viscosity and bond strength are as measured at 23° C. in accordance with JIS K6249.

### Example 1

A polymer of formula (12) below (designated “Polymer Q,” viscosity 10,000 mPa·s, vinyl group content 0.012 mol/100 g) was subjected to Treatment 2 below to form a polymer (designated “Polymer S,” viscosity 11,000 mPa·s, vinyl group content 0.012 mol/100 g). To 100 parts of Polymer S were added 0.20 part of a toluene solution of platinum-divinyltetramethyldisiloxane complex (platinum concentration 0.5 wt %), 0.30 part of a 50% toluene solution of ethynyl cyclohexanol, 11.4 parts of a compound of formula (13) below (Si—H group content 0.063 mol/100 g), 3.84 parts of a compound of formula (14) below (Si—H group content 0.219 mol/100 g), and 14.9 parts of a compound of formula (15). The ingredients were mixed into a composition.

Polymer Q

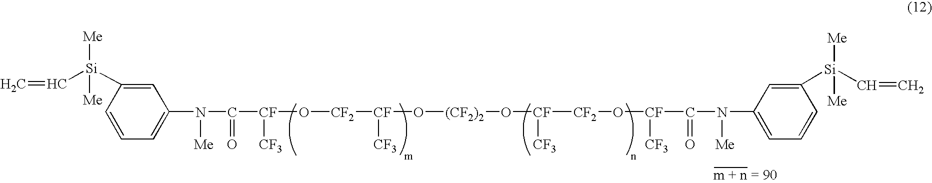

Treatment 2

Polymer Q was vacuum heat treated at 270 Pa and 180° C. for 8 hours.

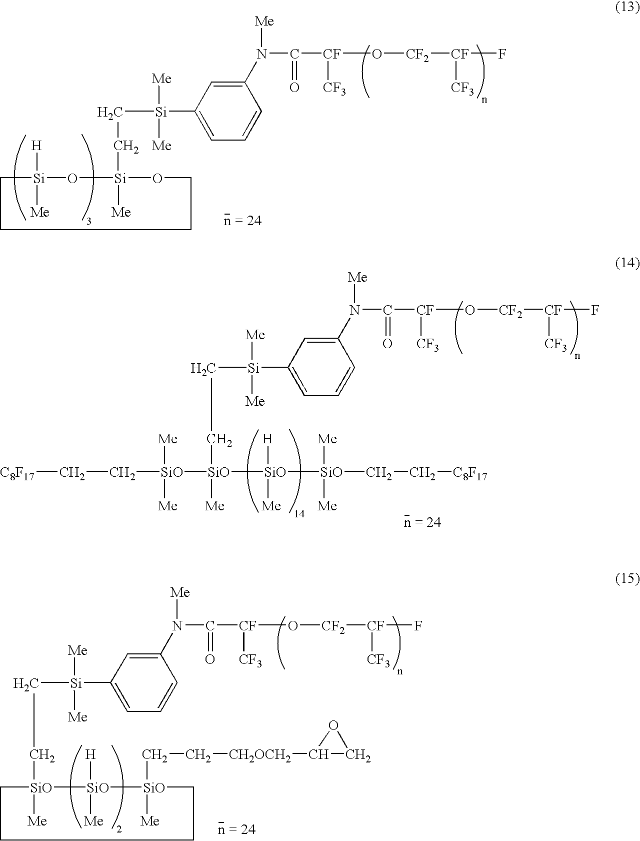

The weight loss of Polymer Q, Polymer S or the compounds of formulae (13) to (15) was determined as follows.

First, the tare weight (W₁) of a clean aluminum dish is measured using a precision balance (reading limit 0.1 mg). A sample of test material is then placed on the dish, and the weight (W₂) of the sample-containing aluminum dish is measured using the precision balance. The sample-containing aluminum dish is held in a thermostat oven at 105° C. for 3 hours. After heating, the aluminum dish is taken out of the oven and allowed to cool down in a desiccator. After cooling, the weight (W₃) of the sample-containing aluminum dish is measured again using the precision balance. Then the percent weight loss of this sample is computed according to the formula:
[(W₃−W₁)/(W₂−W₁)]×100%.
W₁: weight (g) of aluminum dish
W₂: weight (g) of aluminum dish+sample prior to heating
W₃: weight (g) of aluminum dish+heated sample

The weight loss of Polymer Q, Polymer S and the compounds of formulae (13) to (15) as determined above is shown in Table 1.

Next, an outgassing test was carried out on the composition for determining whether or not it yielded outgassing upon heat curing.

As a blank, a clean silicon wafer of 20 mm square was placed in a clean glass dish, which was closed with a lid and held in a thermostat oven at 150° C. for one hour. After heating, the glass dish was taken out of the oven and allowed to cool down in a desiccator for 3 hours. After cooling, the silicon wafer was taken out of the glass dish and measured for contact angle with deionized water. The result is shown in Table 2.

Next, a clean silicon wafer of 20 mm square was placed in a clean glass dish and in contact with 10 g of the composition of Example 1. After the same heating and cooling steps as above, the silicon wafer was measured for contact angle with deionized water. The result is shown in Table 2.

If the composition yields outgassing upon heat curing, the gases deposit on the silicon wafer surface whereby the contact angle of the silicon wafer with deionized water becomes significantly larger than the blank. If the contact angle is substantially equal to the blank, the composition can be judged as yielding little or no outgassing upon heat curing.

### Example 2

A composition was prepared as in Example 1 except that 15.3 parts of a compound of formula (16) below was used instead of the compound of formula (15) in Example 1. The weight loss of the compound of formula (16) was determined as in Example 1, with the result being also shown in Table 1. The composition was tested as in Example 1, with the result being also shown in Table 1.

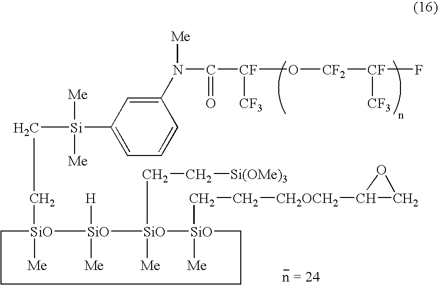

### Example 3

A composition was prepared as in Example 1 except that 15.0 parts of a compound of formula (17) below was used instead of the compound of formula (15) in Example 1. The weight loss of the compound of formula (17) was determined as in Example 1, with the result being also shown in Table 1. The composition was tested as in Example 1, with the result being also shown in Table 1.

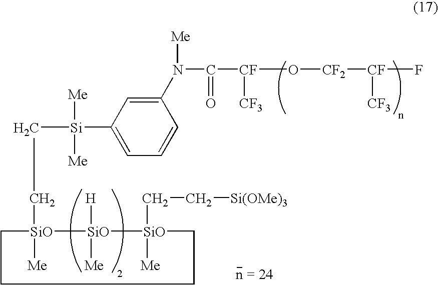

### Comparative Example 1

A composition was prepared as in Example 1 except that 100 parts of Polymer Q was used instead of Polymer S, 1.66 parts of a compound of formula (18) below (Si—H group content 0.429 mol/100 g) was used instead of the compound of formula (13), 1.05 parts of a compound of formula (19) below (Si—H group content 0.821 mol/100 g) was used instead of the compound of formula (14), and 2.50 parts of a compound of formula (20) below was used instead of the compound of formula (15). The weight loss of the compounds of formulae (18) to (20) was determined as in Example 1, with the results being also shown in Table 1. The composition was tested as in Example 1, with the result being also shown in Table 1.

TABLE 1

| | |
|---|---|
| | (18) |
| 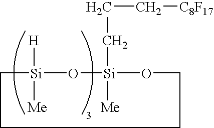 | |
| | (19) |
| 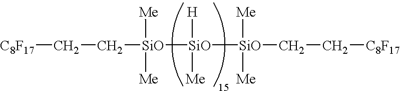 | |
| | (20) |
| 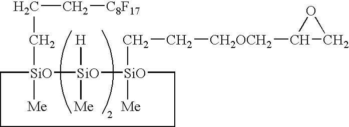 | |

| Material | Weight loss (%) |
|---|---|
| Polymer Q | 0.5 |
| Polymer S | 0.1 |
| Compound (13) | 0.2 |
| Compound (14) | 0.1 |
| Compound (15) | 0.2 |
| Compound (16) | 0.2 |
| Compound (17) | 0.2 |
| Compound (18) | 28.5 |
| Compound (19) | 3.2 |
| Compound (20) | 24.6 |

It is noted that Compound (13) represents the compound of formula (13), and so forth.

TABLE 2

| | | | | Comparative |
|---|---|---|---|---|
| | Example | | | Example |
| | 1 | 2 | 3 | 1 |
| Contact angle (°) | 26 | 25 | 26 | 96 |

Next, adhesion test specimens were prepared by sandwiching a 1 mm thick layer of the composition obtained in Examples 1-3 and Comparative Example 1 between 100×25 mm test panels of the various types of adherends shown in Table 3 arranged with an overlap between their respective edges of 10 mm, and heating at 150° C. for 1 hour to cure the composition. These specimens were then subjected to tensile-shear strength tests (pulling rate, 50 mm/min), and the bond strength (shear bond strength) and cohesive failure rate were evaluated. The results are shown in Table 3.

TABLE 3

| | | | | Comparative |
|---|---|---|---|---|
| Shear strength | Example | | | Example |
| (kgf/cm²) | 1 | 2 | 3 | 1 |
| Glass | 5.4 (100) | 5.7 (100) | 5.5 (100) | 5.5 (100) |
| Aluminum | 6.5 (100) | 6.9 (100) | 6.6 (100) | 6.4 (100) |
| Stainless steel | 5.9 (100) | 6.5 (100) | 6.3 (100) | 6.3 (100) |
| Polyester | 3.6 (100) | 3.8 (100) | 3.6 (100) | 3.5 (100) |
| Epoxy resin | 4.3 (100) | 4.9 (100) | 4.7 (100) | 4.7 (100) |

Values in parenthesis ( ) indicate cohesive failure rate in percent of surface area.

Japanese Patent Application No. 2003-365397 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. An adhesive composition comprising
(A) 100 parts by weight of a linear perfluoropolyether compound containing at least two alkenyl groups per molecule and having a weight loss of up to 0.3%,
(B) a fluorinated organohydrogensiloxane containing at least two silicon atom-bonded hydrogen atoms per molecule and having a weight loss of up to 2.0%, in an amount to provide 0.5 to 3.0 moles of Si—H groups per mole of alkenyl groups in component (A),
(C) 0.1 to 500 ppm of a platinum group compound, calculated as platinum group metal atoms on the basis of the weight of component (A), and
(D) 1 to 50 parts by weight of an organosiloxane containing per molecule at least one hydrogen atom directly bonded to a silicon atom and at least one group selected from among epoxy and trialkoxysilyl groups which is bonded to a silicon atom through a carbon atom or carbon and oxygen atoms and having a weight loss of up to 2.0%.

2. The adhesive composition of claim 1, wherein the linear perfluoropolyether compound (A) has an alkenyl content of 0.002 to 0.3 mol/100 g.

3. The adhesive composition of claim 1, wherein the linear perfluoropolyether compound (A) is of the general formula (1): 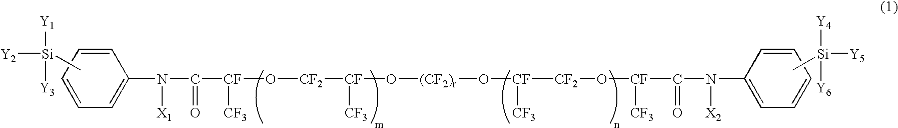
wherein X¹ and X² each are hydrogen, methyl, phenyl or aryl, at least two of Y¹, Y², Y³, Y⁴, Y⁵ and Y⁶ are alkenyl groups, the remaining groups are substituted or unsubstituted monovalent hydrocarbon groups, r is an integer of 2 to 6, m and n each are an integer of 0 to 200, and the sum of m and n is 0 to 400.

4. The adhesive composition of claim 1, wherein the fluorinated organohydrogensiloxane (B) contains at least one monovalent perfluoroalkyl, monovalent perfluorooxyalkyl, divalent perfluoroalkylene or divalent perfluorooxyalkylene group per molecule.

5. The adhesive composition of claim 1, wherein the organosiloxane (D) further contains at least one monovalent perfluoroalkyl or monovalent perfluorooxyalkyl group which is bonded to a silicon atom through a carbon atom or carbon and oxygen atoms.

6. A printing or copying machine in which the adhesive composition of claim 1 is used as a protective sealant or coating.

7. The printing or copying machine of claim 6 which is an ink jet printer or a laser printer.

8. A component for a printing or copying machine, in which component the adhesive composition of claim 1 is used as a protective sealant or coating.

9. The component of claim 10 which is a roller or belt for a printer or copier.
